(19) United States
(12) Patent Application Publication
(10) Pub. No.: US 2026/0279899 A1
(43) Pub. Date: Sep. 17, 2026

(54) LITHIUM STORAGE BODY, ANODE FOR LITHIUM SECONDARY BATTERY INCLUDING THE SAME AND METHOD FOR MANUFACTURING THE LITHIUM STORAGE BODY

(71) Applicants: SK ON CO., LTD., Seoul (KR); UNIVERSITY-INDUSTRY COOPERATION GROUP OF KYUNG HEE UNIVERSITY, Gyeonggi-do (KR)

(72) Inventors: Na Eun YOON, Daejeon (KR); Bit Na CHOI, Daejeon (KR); Byung Gon KIM, Gyeonggi-do (KR); Joo An BANG, Gyeongsangnam-do (KR); Ho Won KANG, Gyeonggi-do (KR)

(21) Appl. No.: 19/568,839

(22) Filed: Mar. 17, 2026

(30) Foreign Application Priority Data
Mar. 17, 2025 (KR) 10-2025-0034131
Mar. 16, 2026 (KR) 10-2026-0046968

(51) Int. Cl. H01M 10/0562; H01M 4/62; H01M 10/0525; H01M 10/058

(52) U.S. Cl. CPC H01M 10/0562; H01M 4/623; H01M 4/625; H01M 10/0525; H01M 10/058; H01M 2300/008

(57) ABSTRACT

The present disclosure provides a lithium storage body including a composite of a sulfide-based solid electrolyte and a conductive material, and an anode for a lithium secondary battery including the same. The lithium storage body includes the composite of the sulfide-based solid electrolyte and the conductive material, thereby improving mechanical properties and electrical characteristics thereof.

### CROSS-REFERENCE TO RELATED APPLICATIONS

This patent application claims the priority and benefits of Korean Patent Application No. 10-2025-0034131 filed on Mar. 17, 2025, and Korean patent application No. 10-2026-0046968 filed on Mar. 16, 2026, which are incorporated herein by reference in their entirety.

### BACKGROUND OF THE INVENTION

### 1. Field of the Invention

The present invention relates to a lithium storage body including a composite of a sulfide-based solid electrolyte and a conductive material, an anode for a lithium secondary battery including the same, and a method for manufacturing the lithium storage body.

### 2. Description of the Related Art

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as hybrid vehicles.

Examples of secondary batteries may include a lithium secondary battery, a nickel-cadmium battery, and a nickel-hydrogen battery. Among these, the lithium secondary battery has a high operating voltage, high energy density per unit weight, and advantages in fast charging and lightweight design.

Since commercially available lithium secondary batteries mainly use liquid electrolytes, there are safety issues such as leakage, ignition, and explosion due to sudden environmental changes, including temperature fluctuations, external impacts and the like. To address these problems, research has been conducted to solidify the electrolyte, thereby enhancing safety and increasing energy density.

Solid electrolytes used in all-solid-state batteries include inorganic solid electrolytes (sulfide-based and oxide-based solid electrolytes) and organic solid electrolytes (polymers). Among these, sulfide-based solid electrolytes are considered to have superior ionic conductivity and battery cell performance.

In relation to the charge-discharge behavior of such all-solid-state batteries, research has been actively conducted on lithium metal anodes in which lithium metal is deposited on an anode, and on anode-free all-solid-state batteries.

### SUMMARY OF THE INVENTION

An object of the present invention is to provide a lithium storage body with improved lithium ion conductivity and electrochemical properties.

Another object of the present invention is to provide an anode with improved lithium ion conductivity and electrochemical properties.

Yet another object of the present invention is to provide a method for manufacturing a lithium storage body with improved lithium ion conductivity and electrochemical properties.

A lithium storage body according to embodiments of the present disclosure includes a composite of a sulfide-based solid electrolyte and a conductive material.

In some embodiments, the conductive material may be positioned in an island shape on a surface of the sulfide-based solid electrolyte.

In some embodiments, the porosity of the lithium storage body may be 10% to 80%.

In some embodiments, the lithium storage body may have an ionic conductivity of 1.3 mS/cm to 4.0 mS/cm.

In some embodiments, the lithium storage body may have an electrical conductivity of 0.24 mS/cm to 0.41 mS/cm.

In some embodiments, the lithium storage body may have a compressive strength of 500 MPa or more.

In some embodiments, the sulfide-based solid electrolyte may be an LPSCl-based solid electrolyte.

In some embodiments, the conductive material may be carbon black.

In some embodiments, the lithium storage body may further include a binder.

In some embodiments, the sulfide-based solid electrolyte may be included in an amount of 92 to 97 parts by weight based on 100 parts by weight of the lithium storage body.

In some embodiments, the conductive material may be included in an amount of 0.01 to 3 parts by weight based on 100 parts by weight of the lithium storage body.

In some embodiments, the binder may be included in an amount of 3 parts by weight or less based on 100 parts by weight of the lithium storage body.

An anode for a lithium secondary battery according to embodiments of the present disclosure includes an anode current collector; and the above-described lithium storage body disposed on the anode current collector.

A method for manufacturing a lithium storage body according to embodiments of the present disclosure includes: preparing a composition for a lithium storage body including a sulfide-based solid electrolyte and a conductive material; compressing the composition for a lithium storage body; and heat treating the compressed composition for a lithium storage body.

In some embodiments, the composition for a lithium storage body may further include a pore-forming agent.

In some embodiments, the composition for a lithium storage body may further include a binder.

In some embodiments, the compressing may be performed at a pressure of 250 MPa to 500 MPa.

In some embodiments, the heat treatment may be performed at a temperature of 300° C. to 400° C.

In some embodiments, the pore-forming agent may be polymethyl methacrylate (PMMA), polystyrene (PS), polyvinylpyrrolidone (PVP), polyethylene glycol (PEG), or polyurea.

In some embodiments, the binder may be polytetrafluoroethylene (PTFE).

The lithium storage body according to embodiments of the present disclosure includes a sulfide-based solid electrolyte, thereby exhibiting excellent ionic conductivity and electrical conductivity.

The lithium storage body according to embodiments of the present disclosure may secure a space for lithium metal deposition, thereby mitigating volume expansion and pressure increase. Accordingly, non-uniform lithium deposition and lithium dendrite growth may be suppressed. As a result, the stability and electrical characteristics of a lithium secondary battery may be improved.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a graph illustrating ionic conductivity of a lithium storage body according to Example 1;

FIG. 2 is a graph illustrating electrical conductivity of the lithium storage body according to Example 1;

FIG. 3 is a graph illustrating ionic conductivity of lithium storage bodies according to Comparative Examples 1 to 3;

FIG. 4 is a graph illustrating electrical conductivity of lithium storage bodies according to Comparative Examples 1 to 3;

FIG. 5 is an SEM image confirming lithium deposition on the lithium storage body according to Example 1;

FIG. 6A is an SEM image of a compressed composition for a lithium storage body before heat treatment;

FIG. 6B is an SEM image of the compressed composition for a lithium storage body after heat treatment; and

FIG. 7 is a graph evaluating charge-discharge characteristics of a lithium secondary battery including the lithium storage body according to an embodiment of the present disclosure.

### DETAILED DESCRIPTION OF THE INVENTION

According to embodiments of the present disclosure, there is provided a lithium storage body including a composite of a sulfide-based solid electrolyte and a conductive material.

Hereinafter, embodiments of the present invention will be described in detail with reference to the drawings. However, the embodiments are merely illustrative, and the present invention is not limited to the specific embodiments described as examples.

The lithium storage body according to the exemplary embodiments may include lithium metal particles. The lithium metal particles may be used as an active material for an electrode for a lithium secondary battery. For example, deposition and detachment reactions of lithium metal, rather than oxidation and reduction reactions of the electrode active material during charge and discharge cycles, may be the primary reversible reactions in a lithium secondary battery.

However, lithium dendrites or lithium ion crystals may grow within the lithium storage body during charge and discharge cycles of the lithium secondary battery. Lithium dendrites or lithium ion crystals have low conductivity and may easily lose electrical contact, which may cause a reduction in the capacity and energy density of the lithium secondary battery.

However, the lithium storage body according to embodiments of the present disclosure may suppress lithium dendrite growth by including a porosity of 10% to 80%, thereby inhibiting problems caused by lithium dendrite growth. In addition, the lithium storage body according to embodiments of the present disclosure may include the composite of a sulfide-based solid electrolyte and a conductive material, thereby increasing ionic conductivity and electrical conductivity and improving energy density.

In some embodiments, the conductive material may be positioned in an island shape on a surface of the sulfide-based solid electrolyte.

The island shape may be a configuration in which the conductive material is discontinuously positioned on the surface of the sulfide-based solid electrolyte. For example, the conductive material particles may be sporadically distributed across the surface of the sulfide-based solid electrolyte. The distribution of the conductive material may have an island shape formed locally on a portion of the surface of the sulfide-based solid electrolyte.

In some embodiments, the porosity of the lithium storage body may be 10% to 80%. For example, the porosity may be 11% to 75%, 11% to 73%, or 11% to 71%.

When the lithium storage body according to an embodiment of the present disclosure satisfies the porosity within the above-described range, the nucleation overpotential during initial lithium deposition may be reduced, the lithium secondary battery may be operated stably, and the current density may be improved.

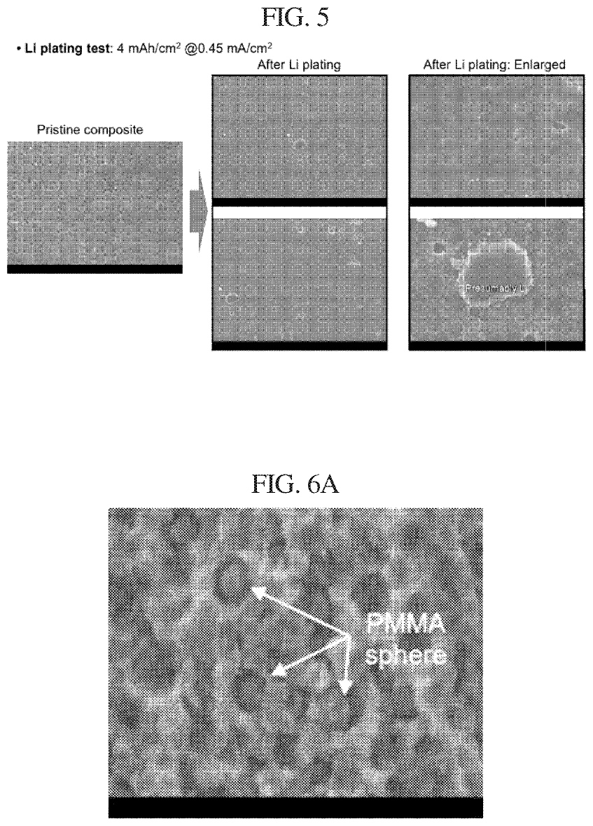

Referring to FIG. 5, when 4 mAh/cm² of lithium is charged into a lithium storage body according to an embodiment of the present disclosure, it can be confirmed that lithium is deposited within pores included in the lithium storage body. If there is no space within the lithium storage body to accommodate lithium, it can be confirmed that lithium is deposited on an upper surface of the lithium storage body.

The porosity may be calculated from Equation 1 below.

$$Porosity of lithium storage body ( \% ) = ( Volume of pore - forming agent ( {cm}^{3} ) ) / ( Volume of sulfide - based solid electrolyte ( {cm}^{3} ) + Volume of conductive material ( {cm}^{3} ) + Volume of pore - forming agent ( {cm}^{3} ) ) \times 100 \qquad [ Equation 1 ]$$

For example, in Equation 1, the volume of the pore-forming agent, the volume of the sulfide-based solid electrolyte, and the volume of the conductive material may refer to values obtained by dividing the respective masses thereof by the respective densities thereof.

In exemplary embodiments, the pores included in the lithium storage body may have an average diameter of 1 μm to 5 μm. For example, the average diameter of the pores may refer to the average diameter of pores observed in an image of the lithium storage body obtained using a scanning electron microscope (SEM).

When the average diameter of the pores satisfies the above-described range, the mobility of lithium ions within the lithium storage body may be enhanced, thereby improving the output characteristics of the lithium secondary battery.

The lithium storage body according to an embodiment of the present disclosure includes a sulfide-based solid electrolyte having high compatibility with lithium metal and metal-containing particles, thereby exhibiting excellent ionic conductivity and electrical conductivity.

In exemplary embodiments, the ionic conductivity of the lithium storage body may be 1.3 mS/cm to 4.0 mS/cm.

For example, the ionic conductivity may be 1.31 mS/cm to 3.99 mS/cm, 1.32 mS/cm to 3.95 mS/cm, 1.33 mS/cm to 3.90 mS/cm, 1.35 mS/cm to 3.85 mS/cm, or 1.36 mS/cm to 3.80 mS/cm.

The ionic conductivity may be measured using an impedance measuring device by a photoelectrochemical impedance spectroscopy (PEIS) method. For example, the ionic conductivity may be measured under conditions of 1 MHz to 0.1 Hz.

When the lithium storage body according to an embodiment of the present disclosure satisfies the ionic conductivity within the above-described range, the output of the lithium secondary battery may be improved and the battery may be charged at high speed.

In exemplary embodiments, the electrical conductivity of the lithium storage body may be 0.24 mS/cm to 0.41 mS/cm.

In exemplary embodiments, the electrical conductivity of the lithium storage body may be 0.24 mS/cm to 0.40 mS/cm.

For example, the electrical conductivity may be 0.241 mS/cm to 0.389 mS/cm, 0.242 mS/cm to 0.388 mS/cm, 0.243 mS/cm to 0.387 mS/cm, 0.244 mS/cm to 0.386 mS/cm, or 0.245 mS/cm to 0.383 mS/cm.

When the lithium storage body according to an embodiment of the present disclosure satisfies the electrical conductivity within the above-described range, deposition on an upper surface thereof and dendrite formation may be suppressed, thereby increasing the discharge capacity of the lithium secondary battery.

The electrical conductivity may be measured using a chronoamperometry (CA) method of electrochemical impedance spectroscopy (EIS). For example, the electrical conductivity may be measured under conditions of 0.05 V.

The lithium storage body according to an embodiment of the present disclosure may have a compressive strength of 500 MPa or more.

In exemplary embodiments, the compressive strength of the lithium storage body may be 500 MPa to 1 GPa.

When the lithium storage body according to an embodiment of the present disclosure satisfies the compressive strength within the above-described range, it may exhibit improved mechanical properties while maintaining an appropriate energy density.

A method for measuring the compressive strength is not particularly limited, and any method commonly used in the art may be applied. For example, the compressive strength may be measured by preparing 10 rectangular specimens cut from 10 different points of the lithium storage body, mounting each specimen on a universal testing machine (UTM), and gradually increasing a compressive load applied to the specimen until the specimen fractures or reaches a proportional limit while continuously applying the load.

In exemplary embodiments, the sulfide-based solid electrolyte may be an LPSCl-based solid electrolyte.

The LPSCl-based solid electrolyte is a solid electrolyte including Li, P, S and Cl. For example, the sulfide-based solid electrolyte may be represented by Formula 1 below.

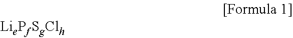

In Formula 1, e, f, g and h satisfy 0<e<12, 0≤f≤6, 0<g≤12, and 0≤h≤9.

In one embodiment, the LPSCl-based solid electrolyte may have an argyrodite-type crystal structure.

The sulfide-based solid electrolyte may have high compatibility with lithium metal and metal-containing particles, thereby further improving the output characteristics of an electrode for a lithium secondary battery. In addition, the sulfide-based solid electrolyte may further enhance the mobility of lithium ions within the lithium storage body. Therefore, localized deposition of lithium metal may be suppressed, further enhancing the stability of the anode for a lithium secondary battery.

The conductive material may further promote electron migration within the lithium storage body. Accordingly, the current density within the lithium storage body may be uniformly distributed, thereby suppressing lithium dendrite growth.

In exemplary embodiments, the conductive material may be a particulate conductive material.

In exemplary embodiments, the conductive material may be a carbon-based conductive material, for example, carbon black. By including carbon black as the conductive material in the lithium storage body, the conductive material may have high compatibility with lithium metal and metal-containing particles.

In exemplary embodiments, the lithium storage body may further include a binder.

The binder may support the lithium storage body by binding or adhering the particles within the lithium storage body to each other. Accordingly, the structural stability of the lithium storage body may be further improved, and the cycle life characteristics of the lithium secondary battery may be further enhanced.

In one embodiment, the binder may include styrene-butadiene rubber (SBR), acrylated styrene-butadiene rubber, acrylonitrile-butadiene rubber, acrylic rubber, an ethylene-propylene copolymer, polyepichlorohydrin, polyphosphazene, polyacrylonitrile, polystyrene, polyvinylpyridine, chlorosulfonated polyethylene, latex, a polyester resin, an acrylic resin, a phenol resin, an epoxy resin, an acrylate resin, polyvinyl alcohol, polyaniline (PANI), polythiophene (PT), polyacetylene, polypyrrole (PPy), poly(3,4-ethylenedioxythiophene) (PEDOT), polyvinylidene fluoride (PVdF), a vinylidene fluoride-hexafluoropropylene copolymer (PVDF-co-HFP), polyvinylpyrrolidone (PVP), polytetrafluoroethylene (PTFE), polymethyl methacrylate, polyethylene, polypropylene, ethylene-propylene-diene monomer (EPDM), and a fluoroelastomer. These may be used alone or in combination of two or more thereof.

Specifically, the binder may be polytetrafluoroethylene (PTFE).

In one embodiment, the sulfide-based solid electrolyte may be included in an amount of 92 to 97 parts by weight based on 100 parts by weight of the lithium storage body.

In some embodiments, the content of the sulfide-based solid electrolyte may be 92 parts by weight or more, 93 parts by weight or more, 94 parts by weight or more, or 95 parts by weight or more based on 100 parts by weight of the lithium storage body.

In some embodiments, the content of the sulfide-based solid electrolyte may be 98 parts by weight or less or 97 parts by weight or less based on 100 parts by weight of the lithium storage body.

The sulfide-based solid electrolyte may be included in an amount of 95 to 97 parts by weight based on 100 parts by weight of the lithium storage body.

When the sulfide-based solid electrolyte satisfies the above-described content within the lithium storage body, local deposition of lithium metal may be suppressed, and the stability of the electrode for a lithium secondary battery may be further improved.

In one embodiment, the conductive material may be included in an amount of 0.01 to 3 parts by weight based on 100 parts by weight of the lithium storage body.

In some embodiments, the content of the conductive material may be 0.015 parts by weight or more, 0.02 parts by weight or more, or 0.03 parts by weight or more based on 100 parts by weight of the lithium storage body.

In some embodiments, the content of the conductive material may be 1 part by weight or less, 0.09 parts by weight or less, 0.08 parts by weight or less, 0.07 parts by weight or less, 0.06 parts by weight or less, or 0.05 parts by weight or less based on 100 parts by weight of the lithium storage body.

The conductive material may be included in an amount of 0.03 to 0.05 parts by weight based on 100 parts by weight of the lithium storage body.

When the conductive material satisfies the above-described content within the lithium storage body, the current density within the lithium storage body may be uniformly distributed, thereby suppressing lithium dendrite growth.

In one embodiment, the binder may be included in an amount of 3 parts by weight or less based on 100 parts by weight of the lithium storage body.

In some embodiments, the content of the binder may be 0.01 parts by weight or more, 0.02 parts by weight or more, 0.03 parts by weight or more, or 0.04 parts by weight or more based on 100 parts by weight of the lithium storage body.

In some embodiments, the content of the binder may be 2 parts by weight or less, 1 part by weight or less, 0.1 parts by weight or less, or 0.09 parts by weight or less based on 100 parts by weight of the lithium storage body.

When the binder within the lithium storage body satisfies the above-described content range, the structural stability and adhesiveness of the lithium storage body may be enhanced, while the energy density may be improved.

Another embodiment of the present disclosure provides an anode for a lithium secondary battery, including an anode current collector and a lithium storage body.

In some embodiments, the anode for a lithium secondary battery may be a lithium metal electrode or an anode-free electrode. The lithium secondary battery may be an all-solid-state battery, and specifically, may be a sulfide-based all-solid-state battery.

In some embodiments, the lithium storage body may be formed on at least one surface of the anode current collector.

The anode current collector may include gold, stainless steel, nickel, aluminum, iron, titanium, copper, or an alloy thereof, and for example, may include copper or a copper alloy.

In one embodiment, the lithium storage body may have a thickness of 5 μm to 100 μm, 10 μm to 80 μm, or 10 μm to 50 μm.

Another embodiment of the present disclosure provides a method for manufacturing the above-described lithium storage body. In one embodiment, the method for manufacturing the lithium storage body may include a step of preparing a composition for a lithium storage body including a sulfide-based solid electrolyte and a conductive material.

The composition for a lithium storage body for manufacturing the lithium storage body may include a sulfide-based solid electrolyte and a conductive material. The sulfide-based solid electrolyte and conductive material applied to the lithium storage body composition may be as described above.

For example, the composition for a lithium storage body may further include a pore-forming agent.

In some embodiments, the pore-forming agent may be polymethyl methacrylate (PMMA), polystyrene (PS), polyvinyl pyrrolidone (PVP), polyethylene glycol (PEG), or polyuria, but is not limited thereto.

For example, the pore-forming agent may be polymethyl methacrylate (PMMA). The polymethyl methacrylate may have a uniform micro-sized bead shape. For example, the polymethyl methacrylate particles may have an average diameter of 1 μm to 12 μm.

In one embodiment, the pore-forming agent may be included in an amount of 5 parts by weight to 60 parts by weight based on 100 parts by weight of the composition for a lithium storage body.

In some embodiments, the pore-forming agent may be included in an amount of 6 parts by weight or more, 7 parts by weight or more, 8 parts by weight or more, or 9 parts by weight or more based on 100 parts by weight of the composition for a lithium storage body.

In some embodiments, the pore-forming agent may be included in an amount of 55 parts by weight or less, 50 parts by weight or less, 45 parts by weight or less, or 40 parts by weight or less based on 100 parts by weight of the composition for a lithium storage body.

The pore-forming agent may be included in an amount of 9 to 40 parts by weight based on 100 parts by weight of the composition for a lithium storage body.

When the pore-forming agent is included in the composition for a lithium storage body within the above-described range, a porosity in a desired amount may be formed within the lithium storage body.

In one embodiment, the composition for a lithium storage body may further include a binder. The binder applied to the composition for a lithium storage body may be as described above.

In one embodiment, the binder may be included in an amount of 3 parts by weight or less based on 100 parts by weight of the composition for a lithium storage body.

In some embodiments, the binder may be included in an amount of 0.1 parts by weight or more, 0.2 parts by weight or more, or 0.3 parts by weight or more based on 100 parts by weight of the composition for a lithium storage body.

In some embodiments, the binder may be included in an amount of 2 parts by weight or less, 1 part by weight or less, 0.9 parts by weight or less, or 0.7 parts by weight or less based on 100 parts by weight of the composition for a lithium storage body.

The binder may be included in an amount of 0.3 parts by weight to 0.7 parts by weight based on 100 parts by weight of the composition for a lithium storage body.

When the binder is included in the composition for a lithium storage body within the above-described range, the structural stability of the lithium storage body may be further improved, and the cycle life characteristics of the lithium secondary battery may be further enhanced.

In one embodiment, the binder may have a glass transition temperature (Tg) of 30° C. or lower, or 25° C. or lower. Accordingly, the binder may have a rubbery state at room temperature, thus a mixture may be prepared by a dry process without additional heat treatment. In the present disclosure, the term “room temperature” may refer to a temperature between 20° C. and 30° C.

In one embodiment, the composition for a lithium storage body may be prepared by a dry process without the use of a solvent. Accordingly, deterioration and consumption of the lithium metal and binder, as well as the generation of side products due to the solvent removal process, may be suppressed.

In addition, since the composition for a lithium storage body is dry-mixed, solvent introduction and removal processes are not required, and an electrochemical deposition process and a lithium metal melting process are not required. Accordingly, economic advantage as well as process efficiency may be further improved.

For example, the sulfide-based solid electrolyte, the conductive material, the pore-forming agent, and the binder may be dry-mixed to form the composition for a lithium storage body.

In one embodiment, the sulfide-based solid electrolyte may be included in an amount of 10 to 80 parts by weight based on 100 parts by weight of the composition for a lithium storage body.

When the sulfide-based solid electrolyte is included in the composition for a lithium storage body within the above-described range, localized deposition of lithium metal may be suppressed, and the stability of the electrode for a lithium secondary battery may be further improved.

In one embodiment, the conductive material may be included in an amount of 0.1 to 3 parts by weight based on 100 parts by weight of the composition for a lithium storage body.

When the conductive material is included in the composition for a lithium storage body within the above-described range, the structural stability and adhesiveness of the lithium storage body may be improved, while the energy density may be further enhanced.

In one embodiment, the method for manufacturing a lithium storage body includes a step of compressing the composition for a lithium storage body.

For example, the compression may be press forming, and the compression may be performed at a pressure of 250 to 500 MPa.

For example, the compression may be performed at room temperature, but is not limited thereto.

The mechanical properties of the lithium storage body, such as tensile strength, may be further improved by the compression.

In one embodiment, the method for manufacturing a lithium storage body may include a step of heat treating the compressed composition for a lithium storage body.

For example, the heat treatment may be performed at a temperature of 300° C. to 400° C.

When the compressed composition for a lithium storage body is heat-treated at a temperature of 300° C. to 400° C., the pore-forming agent may be removed from the compressed composition for a lithium storage body.

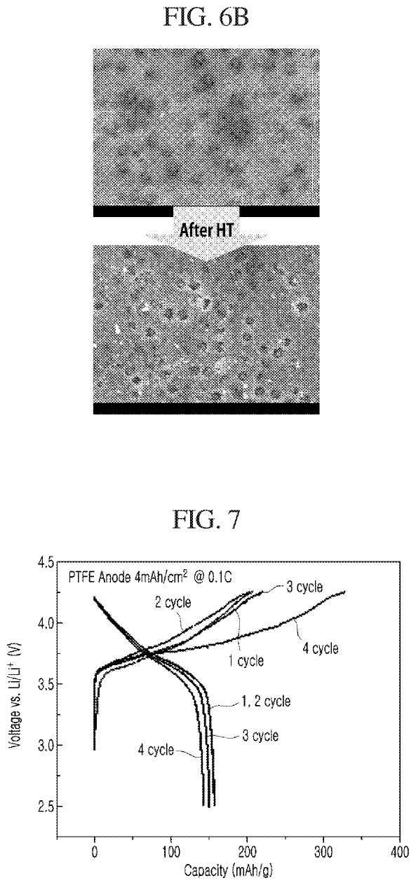

FIG. 6A is an SEM image of a cross-section of the compressed composition for a lithium storage body before heat treatment.

FIG. 6B is an SEM image of a cross-section of the lithium storage body after the compressed composition for a lithium storage body is heat-treated at a temperature of 300° C. to 400° C.

When the heat treatment is performed within the above-described temperature range, the properties of the binder included in the composition for a lithium storage body may be maintained without change, thereby allowing for the proper manufacture of a lithium storage body from the composition for a lithium storage body.

In some embodiments, the lithium storage body manufactured from the composition for a lithium storage body may be bonded to the anode current collector to fabricate an anode.

When the lithium storage body is applied to the anode, a manufacturing process for an electrode layer having a high density may be simplified, and economic advantage as well as process efficiency may be improved.

For example, when inserting lithium metal into the lithium storage body using electrochemical deposition, it may be difficult to uniformly deposit the lithium metal, thereby resulting in a decrease in the density of the electrode layer. In addition, when melting a lithium metal ingot and inserting it into the lithium storage body, a high heat treatment temperature may be required, and economic advantage as well as process efficiency may be reduced.

The lithium storage body may be formed on at least one surface of the anode current collector, or for example, on both surfaces (upper and lower surfaces) thereof.

For example, the composition for a lithium storage body may be molded to manufacture a lithium storage body, and the manufactured lithium storage body may be attached to the anode current collector. In one embodiment, a compression process may be further performed after the lithium storage body is attached to the anode current collector.

In some embodiments, a lithium secondary battery may include the above-described anode according to the embodiments and a cathode disposed opposite the anode.

In one embodiment, the cathode may include a cathode current collector and a cathode active material layer formed on the cathode current collector.

For example, a cathode slurry may be prepared by mixing a cathode active material with a cathode binder, a conductive material, and/or a dispersant in a solvent, followed by stirring. The cathode slurry may be coated on at least one surface of the cathode current collector, followed by drying and roll-pressing to fabricate the cathode.

The cathode current collector may include stainless steel, nickel, aluminum, titanium, or an alloy thereof. The cathode current collector may also include aluminum or stainless steel having a surface treated with carbon, nickel, titanium or silver.

Examples of the cathode active material may include one or more compounds selected from a lithium iron phosphate compound, a lithium cobalt oxide, a lithium manganese oxide, a lithium nickel oxide, or a lithium composite oxide. For example, the cathode active material may include a layered compound such as lithium cobalt oxide (LiCoO₂) or lithium nickel oxide (LiNiO₂), or a lithium manganese oxide such as LiMnO₃, LiMn₂O₃, and LiMnO₂; a lithium copper oxide (Li₂CuO₂); a vanadium oxide such as LiV₃O₈, V₂O₅, and Cu₂VO₇; or a lithium iron phosphate oxide such as LiFePO₄.

In some embodiments, the cathode active material may include a compound represented by Formula 2 below.

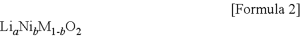

In Formula 2, a and b may satisfy 0.95≤a≤1.08, and b≥0.5, and M may be at least one element selected from the group consisting of Na, Mg, Ca, Y, Ti, Zr, Hf, V, Nb, Ta, Cr, Mo, W, Mn, Co, Fe, Cu, Ag Zn, B, Al, Ga, C, Si, Sn, Ba and Sr.

In one embodiment, the cathode active material includes nickel (Ni) and may further include at least one of cobalt (Co) or manganese (Mn). For example, a nickel-cobalt-manganese (NCM)-based lithium oxide may be used as the cathode active material.

For example, nickel (Ni) may be provided as a metal associated with the capacity of the lithium secondary battery. The higher the content of nickel, the greater the improvement in capacity and output of the lithium secondary battery. However, if the content of nickel increases excessively, the cycle life of the lithium secondary battery may be reduced, and it can be disadvantageous in terms of mechanical and electrical stability.

In one embodiment, the conductivity or resistance of the lithium secondary battery may be improved by cobalt (Co), as well as the mechanical and electrical stability of the lithium secondary battery may be improved by manganese (Mn).

The chemical structure represented by Formula 2 indicates a bonding relationship among elements included in the lattice structure or the crystal structure of the cathode active material, and does not exclude the presence of additional elements. For example, M may be provided as a main active element of the cathode active material. Here, it should be understood that Formula 2 is provided to express the bonding relationship between the main active elements, and is a formula encompassing the introduction and substitution of additional elements.

In one embodiment, the cathode active material may further include auxiliary elements which are added to the main active elements, in order to enhance chemical stability thereof or the crystal structure. The auxiliary element may be incorporated into the crystal structure together to form bonds, and it should be understood that this case is also included within the chemical structure represented by Formula 2.

As the cathode binder, materials that are substantially the same as or similar to the materials described above for the anode for a lithium secondary battery may be used. In one embodiment, a PVDF-based binder may be used as the cathode binder.

The conductive material may include graphite, carbon black, graphene, carbon nanotubes, tin, tin oxide, titanium oxide, and perovskite materials such as LaSrCoO₃, and LaSrMnO₃.

In some embodiments, a separator may be interposed between the cathode and the anode. For example, the separator may be made of a LPSCl-based solid electrolyte, but is not limited thereto.

In some embodiments, the separator may have a thickness 100 μm to 700 μm, but is not limited thereto.

According to exemplary embodiments, the cathode, the anode and the separator may be repeatedly stacked to form an electrode assembly. In some embodiments, the electrode assembly may be a winding type, a stacking type, a z-folding type, or a stacked-folding type.

The electrode assembly may be accommodated in a case to define a lithium secondary battery. The lithium secondary battery may be manufactured, for example, in a cylindrical, prismatic, pouch, or coin type using a can.

In some embodiments, a solid electrolyte layer may be interposed between the anode and the cathode for a lithium secondary battery. The solid electrolyte layer may include a sulfide-based electrolyte. In this case, the lithium secondary battery may not include a separator or a liquid electrolyte. The solid electrolyte layer may substantially function as a separator and may prevent a short circuit between the anode and the cathode for a lithium secondary battery. In addition, the solid electrolyte layer may allow lithium ions to migrate between the cathode and the anode of the lithium secondary battery.

The lithium secondary battery according to embodiments of the present disclosure may be widely applied in green technology fields, including electric vehicles, battery charging stations, and green technology fields including renewable energy systems using batteries, such as solar power generation and wind power generation. In addition, the lithium secondary battery according to embodiments of the present disclosure may be used in eco-friendly electric vehicles and hybrid vehicles to suppress emission of air pollutants and greenhouse gases, thereby contributing to mitigation of climate change.

Hereinafter, the embodiments of the present disclosure will be further described with reference to specific experimental examples. The examples and comparative examples included in the experimental examples are merely illustrative of the present disclosure and do not limit the scope of the appended claims. It will be apparent to those skilled in the art that various changes and modifications to the examples may be made within the scope and technical spirit of the present disclosure, and it is also understood that such changes and modifications fall within the scope of the appended claims.

### PREPARATIVE EXAMPLE

### (1) Manufacture of Lithium Storage Body

### Example

A composition for a lithium storage body was prepared using 0.335 g of argyrodite Li₆PS₅Cl having an average particle size of 5 μm as a sulfide-based solid electrolyte, 0.0025 g of super P as a conductive material, 0.160 g of polymethyl methacrylate (PMMA) as a pore-forming agent, and 0.0025 g of polytetrafluoroethylene (PTFE) as a binder.

The prepared composition for a lithium storage body was pressed at room temperature under a pressure of 500 MPa to produce dry pellets, thereby forming a composite of a sulfide-based solid electrolyte and a conductive material.

The prepared pellets were heat-treated at 400° C. to manufacture a lithium storage body of Example 1.

Lithium storage bodies of Examples 2 to 4 were prepared in the same manner as in Example 1, except that the contents of the sulfide-based solid electrolyte, the conductive material, the pore-forming agent, and the binder were adjusted to the amounts listed in Table 1 below.

TABLE 1

| | Sulfide-based | Conductive | | |
|---|---|---|---|---|
| | solid electrolyte | material | Pore-forming | Binder |
| | (g) | (g) | agent (g) | (g) |
| Example 1 | 0.335 | 0.0025 | 0.16 | 0.0025 |
| Example 2 | 0.31 | 0.0025 | 0.175 | 0.0025 |
| Example 3 | 0.435 | 0.0025 | 0.05 | 0.0025 |
| Example 4 | 0.285 | 0.0025 | 0.2 | 0.0025 |

### Comparative Example

A mixture of Comparative Example 1 was prepared using 0.335 g of argyrodite Li₆PS₅Cl having an average particle size of 5 μm as a sulfide-based solid electrolyte, 0.1 g of N-methyl-2-pyrrolidone (NMP) as a solvent, 0.13 g of polymethyl methacrylate (PMMA) as a pore-forming agent, and 0.015 g of polyamideimide (PAI) as a binder.

Mixtures of Comparative Examples 2 and 3 were prepared in the same manner as in Comparative Example 1, except that the contents of each component were adjusted to the amounts listed in Table 2 below.

TABLE 2

| | Sulfide-based | | | |
|---|---|---|---|---|
| | solid electrolyte | Solvent | Pore-forming | Binder |
| | (g) | (g) | agent (g) | (g) |
| Comparative | 0.335 | 0.1 | 0.13 | 0.015 |
| Example 1 | | | | |
| Comparative | 0.31 | 0.1 | 0.175 | 0.015 |
| Example 2 | | | | |
| Comparative | 0.435 | 0.1 | 0.05 | 0.015 |
| Example 3 | | | | |

### (2) Fabrication of Anode for Lithium Secondary Battery

The lithium storage body according to the example was extruded onto stainless steel (thickness: 10 μm) to fabricate an anode for a lithium secondary battery. The capacity of the anode for a lithium secondary battery was adjusted to approximately 4 mAh/cm².

A slurry was prepared by mixing the mixture according to the comparative example. The slurry was applied onto stainless steel (thickness: 10 μm), followed by drying, and cut to the same size as the anode according to the examples to fabricate an anode for a lithium secondary battery.

### (3) Manufacture of Lithium Secondary Battery

A cathode slurry was prepared by mixing LiNi_{0.6}Co_{0.2}Mn_{0.2}O₂ as a cathode active material, PVdF as a binder, and carbon black as a conductive material in a weight ratio of 92:4:4. The cathode slurry was applied onto an aluminum foil, and then dried and pressed to fabricate a cathode.

The anode and the cathode for a lithium secondary battery were each notched into a circular shape, and a circular LPSCl separator (thickness: 200 μm) was interposed between the anode and the cathode to manufacture an electrode assembly.

The manufactured electrode assembly was assembled into a pouch-cell outer case.

### EXPERIMENTAL EXAMPLE

### (1) Measurement of Porosity

The porosity of the manufactured lithium storage body was calculated using the method in Equation 1 below and the results are shown in Table 3.

$$Porosity of lithium storage body ( \% ) = ( Volume of pore - forming agent ( {cm}^{3} ) ) / ( Volume of sulfide - based solid electrolyte ( {cm}^{3} ) + Volume of conductive material ( {cm}^{3} ) + Volume of pore - forming agent ( {cm}^{3} ) ) \times 100 \qquad [ Equation 1 ]$$

Specifically, the volume of each component was calculated by dividing the mass values of each component listed in Tables 1 and 2 by the respective densities thereof.
Sulfide-based solid electrolyte density: 1.64 g/cm³
Conductive material (super P) density: 160 kg/m³
Pore-forming agent (PMMA) density: 1.18 g/cm³

### (2) Measurement of Ionic Conductivity

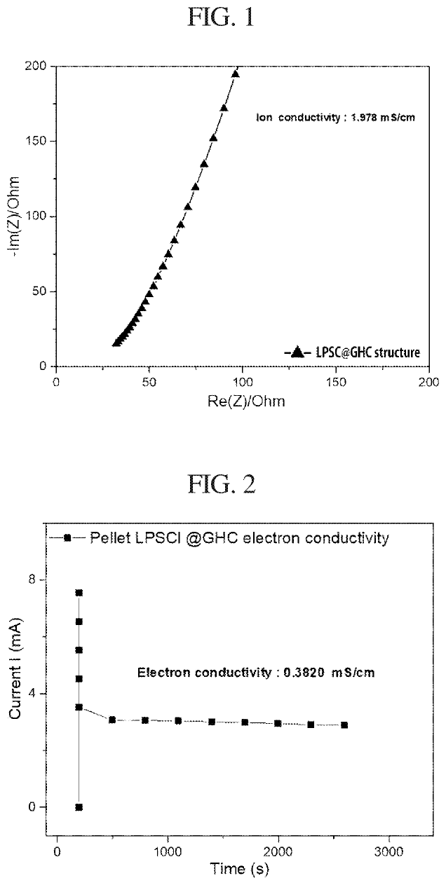

Theionic conductivity of the manufactured lithium storage bodies was measured using an impedance measuring device by a photoelectrochemical impedance spectroscopy (PEIS) method under conditions of 1 MHz to 0.1 Hz and the results are shown in Table 3 below. The ionic conductivity measurement graphs for Example 1 and Comparative Examples 1 to 3 are shown in FIGS. 1 and 3. In FIG. 3, A, B and C represent the ionic conductivity values of Comparative Example 2, Comparative Example 1, and Comparative Example 3, respectively.

### (3) Measurement of Electrical Conductivity

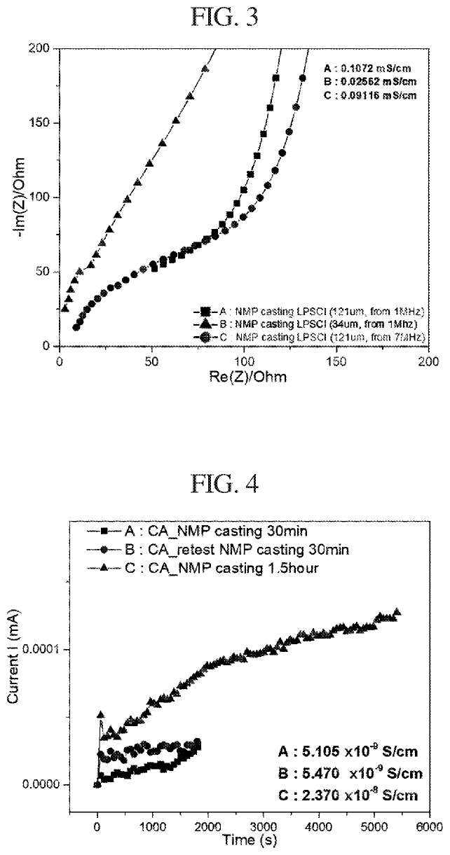

The electrical conductivity of the manufactured lithium storage bodies was measured using a chronoamperometry (CA) method of electrochemical impedance spectroscopy (EIS) under conditions of 0.05 V. The electrical conductivity measurement graphs of Example 1 and Comparative Examples 1 to 3 are shown in FIGS. 2 and 4. In FIG. 4, A, B and C represent the electrical conductivity values of Comparative Example 2, Comparative Example 1, and Comparative Example 3, respectively.

TABLE 3

| | | Ionic | Electrical |
|---|---|---|---|
| | Porosity | conductivity | conductivity |
| | (%) | (mS/cm) | (mS/cm) |
| Example 1 | 36.62 | 1.978 | 0.382 |
| Example 2 | 56.45 | 1.364 | 0.331 |
| Example 3 | 11.49 | 2.01 | 0.246 |
| Example 4 | 70.18 | 0.7945 | 0.268 |
| Comparative | 36.62 | 0.0256 | 5.47 × 10⁻⁶ |
| Example 1 | | | |
| Comparative | 56.45 | 0.1072 | 5.11 × 10⁻⁶ |
| Example 2 | | | |
| Comparative | 11.49 | 0.0912 | 2.37 × 10⁻⁵ |
| Example 3 | | | |

Referring to Table 3, it can be confirmed that the ionic conductivity and electrical conductivity of the lithium storage body according to the examples of the present disclosure are superior to those of the comparative examples.

### (4) Evaluation of Charge and Discharge Characteristics

Constant current charge-discharge evaluations were performed on the cell manufactured in Example 1. Based on the capacity of the cell, charging (CC-CV 0.1 C, 4.2 V, 0.05 C cut-off) and discharging (CC 0.1 C, 2.5 V cut-off) were performed at room temperature as one cycle, and one charge-discharge process was regarded as one cycle. The measurement results are shown in FIG. 7.

What is claimed is:

1. A lithium storage body comprising a composite of a sulfide-based solid electrolyte and a conductive material.

2. The lithium storage body according to claim 1, wherein the conductive material is positioned in an island shape on a surface of the sulfide-based solid electrolyte.

3. The lithium storage body according to claim 1, having an ionic conductivity of 1.3 mS/cm to 4.0 mS/cm.

4. The lithium storage body according to claim 1, having an electrical conductivity of 0.24 mS/cm to 0.41 mS/cm.

5. The lithium storage body according to claim 1, having a compressive strength of 500 MPa or more.

6. The lithium storage body according to claim 1, wherein the sulfide-based solid electrolyte is an LPSCl-based solid electrolyte.

7. The lithium storage body according to claim 1, wherein the conductive material is carbon black.

8. The lithium storage body according to claim 1, further comprising a binder.

9. The lithium storage body according to claim 1, wherein the sulfide-based solid electrolyte is included in an amount of 92 to 97 parts by weight based on 100 parts by weight of the lithium storage body.

10. The lithium storage body according to claim 1, wherein the conductive material is included in an amount of 0.01 to 3 parts by weight based on 100 parts by weight of the lithium storage body.

11. The lithium storage body according to claim 8, wherein the binder is included in an amount of 3 parts by weight or less based on 100 parts by weight of the lithium storage body.

12. An anode for a lithium secondary battery comprising:
an anode current collector, and
the lithium storage body according to claim 1 disposed on the anode current collector.

13. A method for manufacturing a lithium storage body comprising:
preparing a composition for a lithium storage body including a sulfide-based solid electrolyte and a conductive material;
compressing the composition for a lithium storage body; and
heat treating the compressed composition for a lithium storage body.

14. The method for manufacturing a lithium storage body according to claim 13, wherein the composition for a lithium storage body further comprises a pore-forming agent.

15. The method for manufacturing a lithium storage body according to claim 13, wherein the composition for a lithium storage body further comprises a binder.

16. The method for manufacturing a lithium storage body according to claim 13, wherein the compressing is performed at a pressure of 250 MPa to 500 MPa.

17. The method for manufacturing a lithium storage body according to claim 13, wherein the heat treatment is performed at a temperature of 300° C. to 400° C.

18. The method for manufacturing a lithium storage body according to claim 14, wherein the pore-forming agent is polymethyl methacrylate (PMMA), polystyrene (PS), polyvinylpyrrolidone (PVP), polyethylene glycol (PEG), or polyurea.

19. The method for manufacturing a lithium storage body according to claim 15, wherein the binder is polytetrafluoroethylene (PTFE).
